(19) United States
(12) Patent Application Publication
(10) Pub. No.: US 2020/0280932 A1
(43) Pub. Date: Sep. 3, 2020

(54) METHOD OF ESTABLISHING WIRELESS CONNECTION BETWEEN A MOBILE CONTROLLER AND A CONTROLLABLE DEVICE

(71) Applicant: Dyson Technology Limited, Wiltshire (GB)

(72) Inventors: Alan DOWN, Bristol (GB); Timothy David HUTT, Bristol (GB); Laurence Charles Richard HERBERT, Salisbury (GB); Matthew HAZLEY, Bristol (GB); Alex James LAYTON, Birmingham (GB); Matthew Nicholas ARANHA, Swindon (GB); Daniele PIETROBELLI, Swindon (GB)

(73) Assignee: Dyson Technology Limited, Wiltshire (GB)

(21) Appl. No.: 16/645,690

(22) PCT Filed: Aug. 14, 2018
(86) PCT No.: PCT/GB2018/052301

§ 371 Date: Mar. 9, 2020

(30) Foreign Application Priority Data
Sep. 11, 2017 (GB) 1714585.5

(51) Int. Cl. H04W 52/32; H04W 76/19; H04W 52/14; H04W 52/28; H04W 76/14

(52) U.S. Cl. CPC H04W 52/322; H04W 76/19; H04W 76/14; H04W 52/283; H04W 52/146

(57) ABSTRACT

In a wireless communication between a mobile controller and a controllable device, the device periodically broadcasts, at a relatively low power level, a first advertisement packet for connecting the controllable device to a mobile controller. Once a connection has been established between the device and the controller, the controller and the device exchange their respective identifiers (IDs). In the event that the connection becomes broken, the device starts to additionally periodically broadcast, at a relatively high power level, a second advertisement packet containing the device ID for reconnecting the device to the controller. Upon receipt of the second packet, the controller requests receipt of a message containing the controller ID and, upon receipt of that message, resumes the connection with the device. The device then stops the broadcast of the second advertisement packet.

### REFERENCE TO RELATED APPLICATIONS

This application is a national stage application under 35 USC 371 of International Application No. PCT/GB2018/052301, filed Aug. 14, 2018, which claims the priority of United Kingdom Application No. 1714585.5, filed Sep. 11, 2017, the entire contents of each of which are incorporated herein by reference.

### FIELD OF THE DISCLOSURE

The present invention relates to a method of establishing wireless connection between a mobile controller and a controllable device. The present invention also relates to a wireless communication system and to a controllable device for use in such a system. In a preferred embodiment, the controllable device is a domestic controllable device, such as a lighting device, an environmental control device, a surface treating appliance, or a personal care appliance.

### BACKGROUND OF THE DISCLOSURE

Bluetooth technology is commonly used to connect a controllable device to a mobile controller, such as a mobile telephone or a tablet. To establish a connection, the controllable device is placed in an advertising mode, in which advertisement packets are broadcast to enable a connection to be made with a controller placed in a scanning mode.

Depending on the transmission power level, the advertising packets may be broadcast to a distance of up to 10 m, which can enable the device to become connected to a controller located remotely from the device. However, when there are several similar types of connectable device located within the same local environment, such as desk lights or fans located in an open plan office environment, there is a risk that a controller of one user may become inadvertently connected to a controllable device assigned to another user, for example a device located on an adjacent desk or workspace, or as the user of the controller walks through the office.

### SUMMARY OF THE DISCLOSURE

In a first aspect, the present invention provides method of establishing wireless connection between a mobile controller and a controllable device, comprising the steps of:
at the controllable device, which has a device identifier (ID):
   (i) periodically wirelessly broadcasting, at a relatively low power level, from the controllable device a first advertisement packet for connecting the controllable device to a mobile controller;
at the mobile controller, which has a controller ID:
   (ii) receiving the first advertisement packet;
   (iii) establishing a wireless connection with the controllable device;
   (iv) receiving the device ID from the connected controllable device; and
   (v) storing the device ID;
at the controllable device:
   (vi) receiving the controller ID for the connected mobile controller; and
   (vii) storing the controller ID;
      and, when the connection between the mobile controller and the controllable device becomes broken, further comprising the steps of:
at the controllable device:
   (viii) additionally periodically wirelessly broadcasting, at a relatively high power level, a second advertisement packet for reconnecting the controllable device to the mobile controller, the second advertisement packet containing the device ID;
at the mobile controller:
   (ix) receiving the second advertisement packet;
   (x) comparing the device ID contained in the second advertisement packet with a stored device ID;
   (xi) depending on the result of the comparison at step (x), requesting transmission of the controller ID stored by the controllable device;
   (xii) receiving the stored controller ID from the controllable device;
   (xiii) comparing the stored controller ID received from the controllable device with the controller ID of the mobile controller; and
   (xiv) depending on the result of the comparison at step (xiii), resuming the wireless connection between the mobile controller and the controllable device; and
at the controllable device:
   (xv) when the connection has been resumed, stopping the broadcast of the second advertisement packet.

By controlling the device to periodically wirelessly broadcast the first advertisement packet at a relatively low power, the user has to place the mobile controller close to, or against, the controllable device in order to establish the connection between the controller and the device. This reduces the risk of the controller forming connections with other similar devices in the local vicinity, for example on adjacent desks within an office environment. The first advertisement packet is preferably broadcast to a distance of up to 30 cm, more preferably to a distance of up to 15 cm.

In the event that the connection between the mobile controller and the controllable device becomes broken, the device is controlled to additionally periodically wirelessly broadcast, at a relatively high power level, a second advertisement packet for reconnecting the controllable device to the mobile controller.

To ensure that the connection is re-established with the same mobile controller which had previously been connected to the device, the second advertisement packet contains a unique device identifier (ID) for the device. The mobile controller which had previously been connected to the device is aware of that device ID through an exchange of identifiers between the controller and the device following the establishment of the connection between the controller and the device. In a preferred embodiment, the steps (iv) to (vii) are performed in turn, with the controller first receiving and storing the device ID, followed by the device then receiving and storing a unique controller ID for the controller. However, alternatively steps (vi) and (vii) may be performed before steps (iv) and (v).

Other mobile controllers whose most recent wireless connection had not been established with that device will ignore the second advertisement packet, but ones whose most recent wireless connection had been with that device, and which receive the second advertisement packet, will, in response to the receipt of the second advertisement packet, request receipt from the device of the controller ID which is stored in memory of the device. Upon receipt of the controller ID stored by the device, the controller confirms that this controller ID is the same as its own controller ID before re-establishing the connection with the device.

This means that only the controller with which the device had most recently been connected can re-establish the wireless connection with the device by means of the second advertisement packet. By broadcasting the second advertisement packet at a relatively higher power, this saves the user of that controller from having to purposefully reconnect the controller to the device by placing the controller in the immediate vicinity of the device. The second advertisement packet is preferably broadcast to a distance in the range from 1 to 10 m. This enables the connection to become re-established when a user of the controller is located, for example at a desk or table upon which the device is located, or within the same room or office environment as the device.

Preferably, the first advertisement packet and the second advertisement pack are periodically broadcast at the same fixed interval. The fixed interval is preferably in the range from 50 to 500 ms. In a preferred embodiment, the fixed interval is 270 ms. The broadcasts of the first advertisement packet and the second advertisement packet are preferably staggered. In a preferred embodiment, the time interval between a broadcast of a first advertisement packet and a broadcast of a second advertisement packet is 90 ms.

The first advertisement packet continues to be periodically wirelessly broadcast, both while the connection with the mobile controller is established and once the connection with the mobile controller has become broken. This means that the connection between the connected device and the mobile controller may be replaced by a connection between the connected device and a second mobile controller having a unique second controller ID by performing steps (ii) to (vii) above with the second mobile controller. In step (v), the second mobile controller overwrites the device ID of any similar device to which it had previously been connected with the device ID of the device, and in step (vii), the device overwrites the controller ID of the first mobile controller with the controller ID of the second mobile controller. Once that connection between the device and the second mobile controller has been established, the first mobile controller is no longer connected to the device, and so would need to be placed in immediate proximity to the device in order to receive the first advertisement packet to re-establish a connection with the device. In the event that the connection between the device and the second mobile controller were to become broken, only the second mobile controller would be able to re-connect to the device by means of the second advertisement packet, as the device would currently be storing the controller ID of the second mobile controller, not the controller ID of the first mobile controller.

Preferably, a beacon for activating a program stored on the mobile controller is periodically wirelessly broadcast by the device. The program is preferably a mobile application program, or app, which enables a user of the controller to control functions or operations of the device. The beacon is preferably broadcast by the device at the relatively low power level so that the program is only activated by the beacon when the controller has been placed in the immediate vicinity of the device, and so both when a user of the controller requires a connection to be established with the device and when it is most likely that the user of the controller would want to change one or more of the functions or settings of the device. The first advertisement packet and the beacon are preferably periodically broadcast at the same fixed interval. The broadcasts of the first advertisement packet, the second advertisement packet and the beacon are preferably staggered, and preferably such that there is the same fixed interval between each broadcast.

The controller is preferably a handheld mobile device such as a mobile phone, a tablet computer, a laptop computer, a watch, a key fob or a personal digital assistant.

The device is preferably a controllable domestic appliance. The device may be a lighting device, such as a desk-standing lamp or a floor-standing lamp. Alternatively, the device may be an environmental control appliance, such as a fan, a heater, an air purifier or an air conditioning unit. As a further alternative, the device may be a personal care appliance, such as a hair dryer, a hair straightener or a dental cleaning appliance, or a surface treating appliance such as a vacuum cleaner. As further alternatives, the device may be a media player, a vehicle or a wearable appliance, such as a headset.

In a second aspect, the present invention provides a controllable device for use in a wireless communication system, the controllable device comprising:

a transceiver;

a memory storing a device identifier (ID) associated with the device;

a microcontroller connected to the transceiver and the memory, the microcontroller being configured to control the transceiver to periodically wirelessly broadcast, at a relatively low power level, a first advertisement packet for connecting the controllable device to a mobile controller, establish a connection between the controllable device and a mobile controller, receive from the transceiver a first message having a payload containing a controller ID for the connected mobile controller; and store the controller ID in the memory;

and wherein the microcontroller is configured to control the transceiver to additionally periodically wirelessly broadcast, at a relatively high power level, a second advertisement packet for reconnecting the controllable device to the mobile controller when the connection becomes broken, the second advertisement packet containing the device ID, receive from the transceiver a request for the stored controller ID, control the transceiver to transmit, in response to the request, a second message having a payload containing the stored controller ID, and stop the broadcast of the second advertisement packet when the connection with the mobile controller has been resumed.

In a third aspect, the present invention provides a wireless communication system comprising a mobile controller and a controllable device as aforementioned.

The mobile controller preferably comprises a transceiver, a memory storing a controller identifier (ID) associated with the controller, and a microcontroller connected to the transceiver and the memory.

Upon receipt of a first advertisement packet, the microcontroller is preferably configured to establish a wireless connection with the controllable device, receive from the transceiver a message having a payload connecting the device ID for the connected controllable device, and store the device ID contained in that message in the memory of the controller. This message is preferably identical to the second message, and so the second message preferably contains both the device ID and identifier of the controller which was most recently connected to the device.

Upon receipt of a second advertisement packet, the microcontroller is preferably configured to compare the device ID contained in the second advertisement packet with a stored device ID, depending on the result of the comparison request transmission of the controller ID stored by the controllable device, compare the stored controller ID received from the controllable device with the controller ID of the mobile controller, and, depending on the result of that comparison, resume the wireless connection between the mobile controller and the controllable device.

Features described above in connection with the first aspect of the invention are equally applicable to the second and third aspects of the invention, and vice versa.

### BRIEF DESCRIPTION OF THE FIGURES

Preferred features of the present invention will now be described by way of example only with reference to the accompanying drawings, in which:

FIG. 1 is a block diagram of a controllable device and a mobile controller of a wireless communication system;

FIG. 2 illustrates steps performed by the controllable device to establish a wireless connection with the mobile controller;

FIG. 3 illustrates steps performed by the mobile controller to establish a wireless connection with the controllable device;

FIG. 4 illustrates the variation of the transmitted power with time during periodic wireless broadcast of beacons and first advertising packets by the controllable device;

FIG. 5 illustrates the variation of the transmitted power with time during periodic wireless broadcast of beacons, first advertising packets and second advertising packets by the controllable device; and

FIG. 6 illustrates steps performed by the controllable device to resume the wireless connection with the mobile controller.

### DETAILED DESCRIPTION OF THE DISCLOSURE

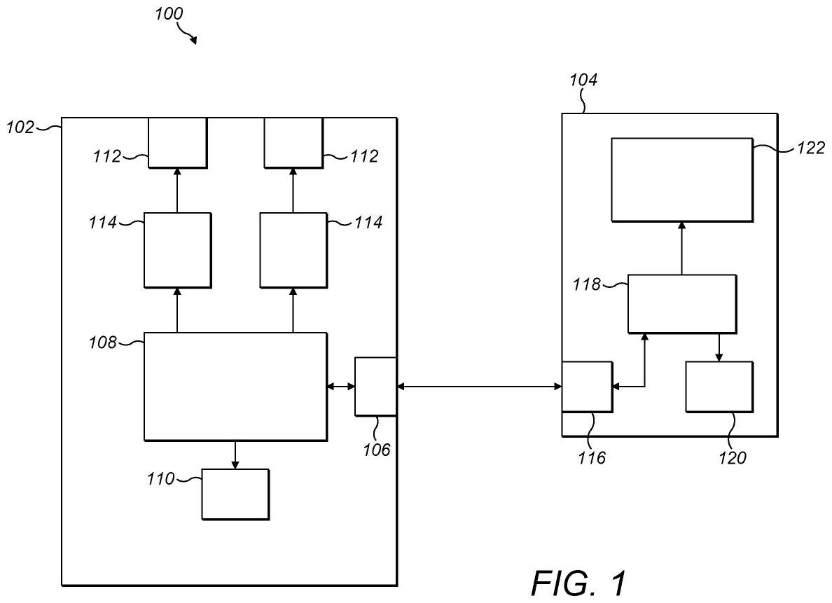

FIG. 1 shows a simplified functional block diagram of an embodiment of a wireless communication system 100. The wireless communication system 100 comprises a connectable device 102 and a mobile controller 104. Each of the device 102 and the controller 104 may be a stand-alone device, or may be a portion of circuitry integrated in another device.

The device 102 is preferably a controllable domestic appliance, which in this embodiment is a lighting device or luminaire such as a desk-standing lamp or a floor-standing lamp, but other examples of a controllable device include a fan, a heater, an air purifier, an air conditioning unit, a personal care appliance, such as a hair dryer, a hair straightener or a dental cleaning appliance, a surface treating appliance and a vehicle. In this embodiment, the controller 104 is a handheld mobile device such as a mobile phone, but other examples of a mobile controller include a tablet computer, a laptop computer, a watch and a personal digital assistant.

The controller 104 has suitable stored software for establishing wireless communication with the device 102. The wireless communication between the device 102 and the mobile controller 104 is preferably via a short-range radio connection. This includes WPAN standards such as Bluetooth and ZigBee, and WLAN standards such as Wi-Fi/IEEE802.11 and DECT. In this embodiment, wireless communication is established by means of Bluetooth Low Energy (BLE) technology, in which the device 102 broadcasts advertising packets for reception by Bluetooth enabled mobile controllers located within the range of the broadcast. A mobile controller which receives these packets can respond to the data contained within the payload of the packet, or establish a wireless connection with the device 102.

With reference to FIG. 1, the device 102 comprises a transceiver 106 for broadcasting advertising packets and messages, and for receiving messages transmitted to the device 102 by a mobile controller. The transceiver 106 may be arranged to broadcast advertising packets on a single advertising channel, or sequentially on a plurality of advertising channels; the following discussion refers only to broadcasts made on one such advertising channel but may be readily applied to broadcasts on a plurality of advertising channels. The transceiver 106 is connected to and controlled by a microcontroller 108, which receives incoming messages from the transceiver 106 and instructs the transceiver 106 to broadcast or transmit responses to the received messages. The microcontroller 108 comprises a circuit, integrated circuit or processor operable to control operation of the transceiver 106 and other components of the device 102.

The microcontroller 108 is also connected to a memory 110. The memory 110 stores two types of identifier (ID) which are associated with the device 102. The first identifier is a generic model ID which is associated with the device model. For example, in this embodiment the model ID identifies the device 102 as a particular type of desk light. The second identifier is a device ID which is unique to that device 102. In this embodiment, the device 102 is in the form of a lighting device and so the device 102 also includes LEDs 112 and LED drivers 114 driven by the microcontroller 108, or by a dedicated microcontroller connected to the microcontroller 108. The microcontroller 108 is connected to a source of power, such as a battery, or is connectable to a wall socket by means of a cable.

With reference also to FIG. 1, the controller 104 also comprises a transceiver 116, a microcontroller 118 connected to the transceiver 116, and a memory 120 connected to the microcontroller 118. The microcontroller 118 is configured to scan the advertising channels for advertising packets broadcast from devices 102 with which the controller 104 is configured to establish a wireless connection. Once a connection has been established with a device 102, the microcontroller 118 can instruct the transceiver 116 to transmit messages to the connected device 102. The memory 120 stores a controller ID which is unique to that controller 104, and software in the form of a mobile application which is launched to establish a wireless connection with the device 102, and to control functions of the connected device 102. In this embodiment where the device 102 is a lighting device, the mobile application may be used by a user of the controller 104 to control functions such as the switching on and off of the device 102, the scheduling of operations of the device 102 and the adjustment of the intensity and/or color temperature of the light emitted from the device 102. In this embodiment, the controller 104 is in the form of a mobile phone and so the controller also includes a user interface 122, which may comprise a display and/or a keyboard. The microcontroller 118 is connected to a source of power, such as a rechargeable battery.

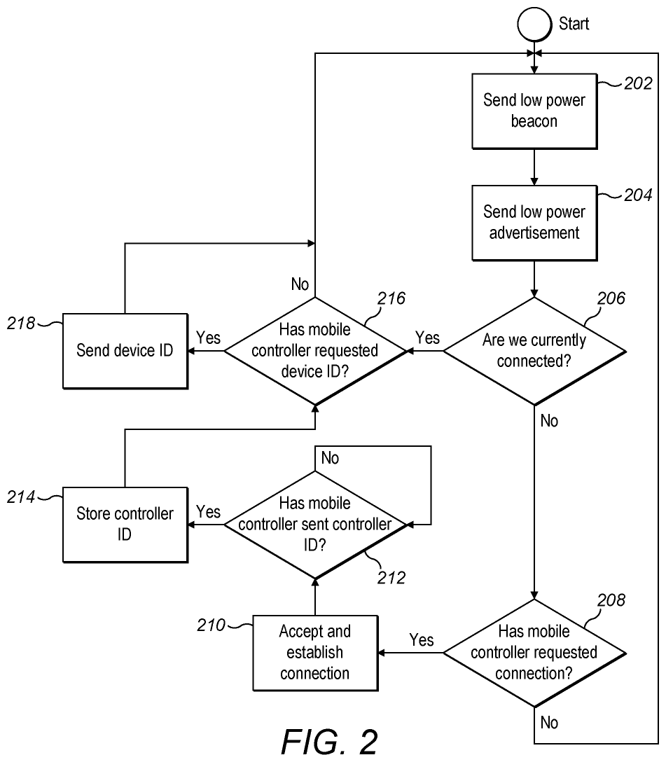

The establishment of a connection between the device 102 and the controller 104 will now be described with reference to FIGS. 2 to 4. Once the controller 104 has been switched on, at step 302 the microcontroller 118 determines whether the controller 104 is currently connected to a controllable device 102. As no connection has yet to be established between the controller 104 and a controllable device 102, the microcontroller 118 monitors data received by the transceiver 116 for transmissions from a controllable device 102.

Once the device 102 has been switched on, at step 202 the microcontroller 108 of the device 102 controls the transceiver 106 to periodically wirelessly broadcast a beacon B1 for automatically launching the mobile application stored in the memory 120 of the controller 104. The beacons B1 are broadcast at a fixed time interval which is between 50 and 500 ms, and in this embodiment is 270 ms. The microcontroller 108 is configured to control the power setting at which the beacons B1 are broadcast so that the range of the beacons B1 is relatively low. In this embodiment, the beacons B1 are broadcast at a relatively low transmitted power level so that the beacons B1 are preferably broadcast to a distance of no more than 30 cm from the transceiver 106, more preferably to a distance of no more than 15 cm from the transceiver 106. This means that a user would have to place the controller 104 in immediate proximity to, or against, the transceiver 106 for a time period of no more than 500 ms in order to receive a beacon B1. The transceiver 106 is preferably located in a prominent location on the device 102, for example adjacent to the LEDs 112 or an operating switch of the device 102 to facilitate the user placing the controller in immediate proximity to the transceiver 106. Alternatively, the location of the transceiver 106 may be identified by a symbol or other marking provided on the external surface of the device 102.

In addition to the periodic broadcast of the beacons B1, the transceiver 106 is also controlled to periodically wirelessly broadcast first advertising packets P1 on an advertising channel so as to establish a wireless connection with a mobile controller 104. The packets P1 are broadcast in a staggered manner with the beacons B1, with each packet P1 being broadcast immediately after a respective beacon B1. The packets P1 are broadcast with the same fixed time interval as the beacons B1, with the time interval between the broadcast of a beacon B1 and the broadcast of a packet P1 preferably in the range from 50 to 100 ms. In this embodiment, the time interval between the broadcast of a beacon B1 and the subsequent broadcast of a packet P1 is 90 ms. The payload of the packets P1 contains the model ID of the device 102, so that a controller 104 which receives a first packet P1 is able to identify a generic source of the packet P1, that is, that the first packet P1 has been broadcast by a model of lighting device with which the mobile application stored in the memory 120 of the controller 104 is compatible.

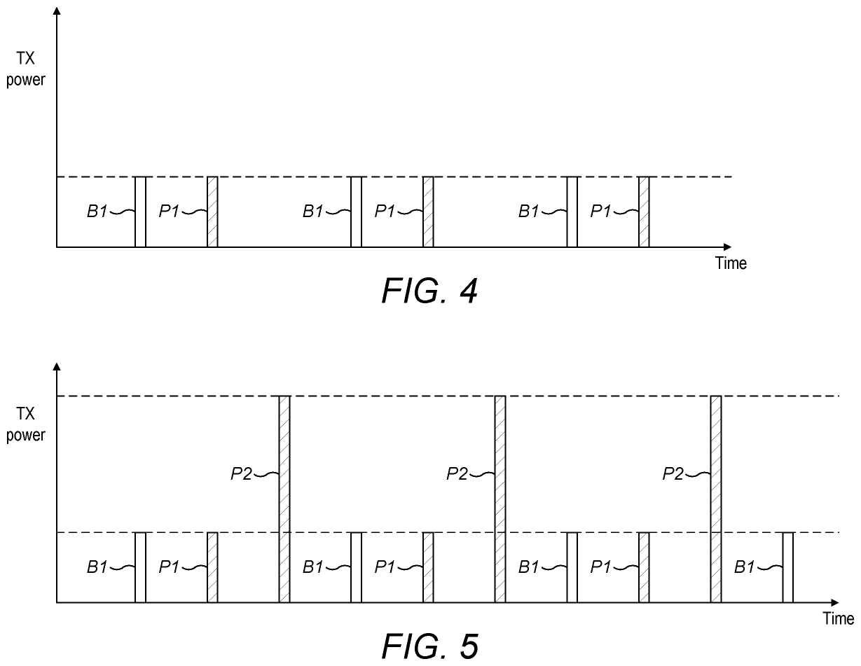

As illustrated in FIG. 4, the packets P1 are also broadcast at the same or a similar relatively low transmitted power level as the beacons B1. This means that the user has to maintain the controller 104 in immediate proximity to, or more preferably against, the transceiver 106 for only an additional short period of time in order to receive the packets P1. This proximity requirement also reduces the risk of the controller 104 becoming undesirably connected to other similar devices in the vicinity of the device 102, for example as the user moves around the office.

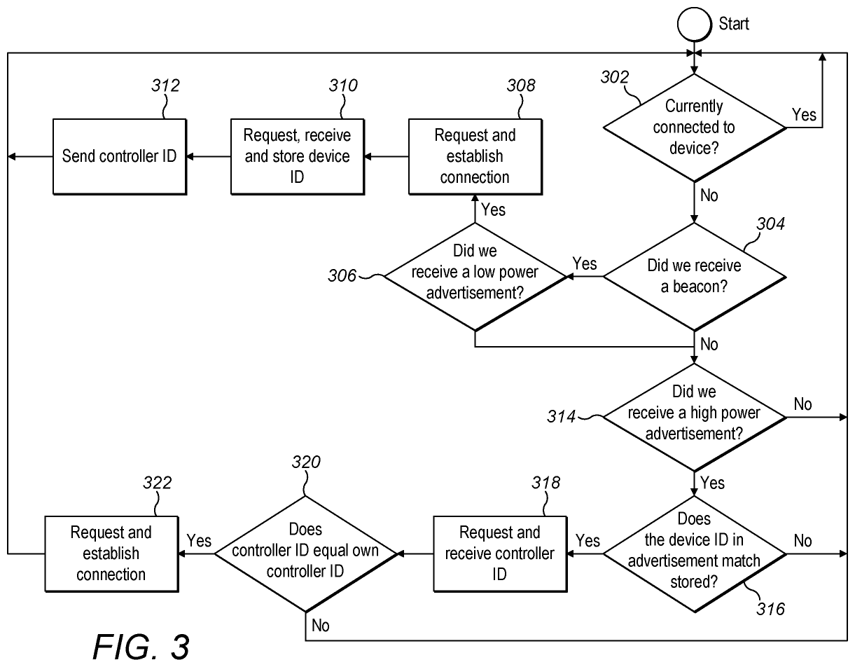

Reverting back to FIGS. 2 and 3, at steps 206 and 208 the microcontroller 108 also periodically checks whether the device 102 is connected to a mobile controller 104, and whether the connection has been requested by a mobile controller 104.

Once the controller 104 has been placed in immediate proximity to the transceiver 106 of the device 102, the beacon B1 and the packet P1 can be received by the microcontroller 118 of the controller 104 via the transceiver 116. In response to the receipt of the beacon B1 the mobile application is launched on the controller 104 by the microcontroller 118. Once the microcontroller 118 has determined at steps 304 to 306 that both a beacon B1 and a packet P1 have been received, at steps 308 and 210 the microcontrollers 108, 118 establish the wireless connection between the device 102 and the controller 104.

Once the controller 104 has become connected to the device 102, the device 102 and the controller 104 exchange their unique identifiers. At step 310 the controller 104 transmits to the device 102 a first message having a payload which contains the controller ID. At steps 212 and 214, upon receipt of the first message the microcontroller 108 stores the controller ID in the memory 110 of the device 102. In the event that the device 102 were to become connected to a second controller, then the stored controller ID is overwritten by the ID of the connected second controller. At step 312, the controller 104 transmits to the device 102 a second message requesting receipt of the device ID. At steps 216 and 218, the second message is received by the device 102, in response to which the device 102 transmits a third message having a payload which contains both the device ID and the controller ID stored in the memory 110 of the device 102. Upon receipt of the third message the microcontroller 118 stores the device ID in memory 120. In the event that the controller 104 were to become connected to a second device, then the stored device ID is overwritten by the ID of the connected second device.

Following the establishment of the connection between the device 102 and the controller 104, the launched mobile application can be used to control various different functions of the device 102, and/or to display information concerning usage or operation of the device 102. The wireless communication between the device 102 and the controller 104 may be performed whilst the controller 104 remains connected to the device 102, which may be to a separation between the device 102 and the controller of up to 30-50 m depending on factors such as the output power and sensitivity of the transceivers 106, 118, and the nature of any physical objects located between the device 102 and the controller 104.

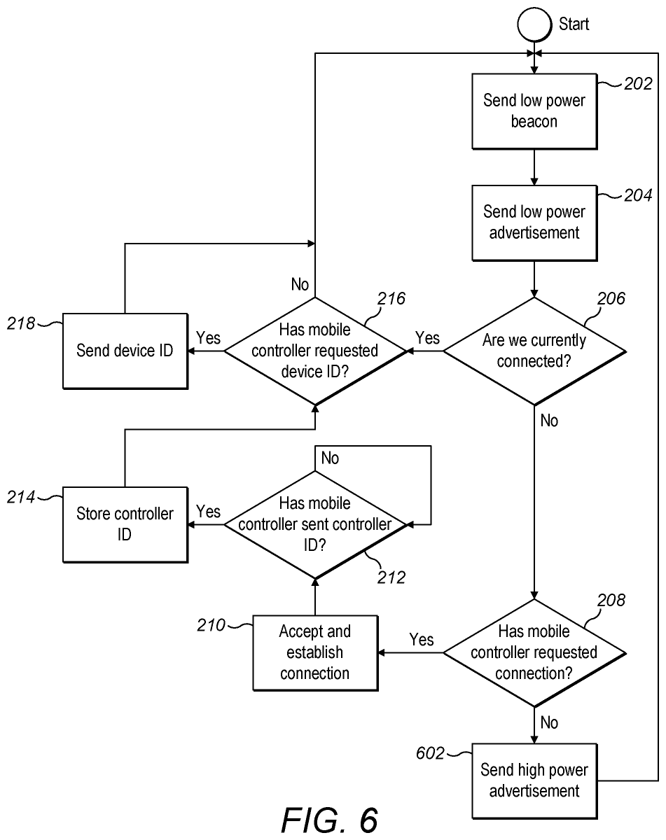

With reference to FIGS. 5 and 6, in the event that at steps 206, 208 the device 102 establishes that the connection with the controller 104 has become broken, for example due to the controller 104 moving out of communication range with the device 102, or due to the user of the controller 104 having requested disconnection from the device 102, and that no connection is currently being requested by the controller 104, then the device 102 performs the additional step of periodically wirelessly broadcasting second advertising packets P2 on the advertising channel so as to re-establish the wireless connection with the mobile controller 104 with which it has previously been in wireless communication, but not with other mobile controllers.

The packets P2 are broadcast in a staggered manner with the beacons B1 and packets P1, with each packet P2 being broadcast immediately after a respective packet P1. The packets P1 are broadcast with the same fixed time interval as the beacons B1 and packets P1, with the time interval between the broadcast of a packet P1 and the broadcast of a packet P2 preferably in the range from 50 to 100 ms. In this embodiment, the time interval between the broadcast of a packet P1 and the subsequent broadcast of a packet P2 is also 90 ms.

In contrast to the beacons B1 and packets P1, the packets P2 are broadcast at a relatively high transmitted power level so that the packets P2 are preferably broadcast to a distance of up to 1-10 m from the transceiver 106. This means that a user would not have to place the controller 104 in immediate proximity to the transceiver 106 to resume the connection with the device 102, but instead may resume the connection with the device 102 once in near proximity to the device 102, for example, at one extreme, once sat at a desk upon which the device 102 is located, or, at another extreme, located in the same room as the device 102. The reconnection of the device 102 with the controller 104 also does not need to be made whilst the mobile application is launched on the controller 104, as, if the user had only been temporarily away from the device 102, there may be no desire to change any setting of the device 102 and so no need to launch the mobile application, thereby conserving power at the controller 104.

As the packets P2 are broadcast with a relatively long range, the packets P2 may overlap with packets P1 broadcast by a second device located within the range of the packets P2, for example a second device positioned on an adjacent desk within the office environment. In view of this, in contrast to the packets P1 the payload of the packets P2 contains the device ID of the device 102, so as to distinguish the packets P2 from packets P1 broadcast both from the device 102 and from any other similar devices located within range of the packets P2.

Returning to FIG. 3, upon receipt of packet P2 the controller 104 initiates a process for verifying that the controller 104 had been previously connected to the device 102. First, at steps 314 and 316 the microcontroller 118 of the controller 104 compares the device ID contained in packet P2 with the device ID stored in memory 120. If the device ID contained in the packet P2 is not the same as the stored device ID, then no connection is established between the device 102 and the controller 104. This may be the case where the controller 104 had, subsequent to the breaking of the connection with the device 102, established a connection with a second device, in which case the device ID of the second device would be stored in the memory 120 of the controller 104.

On the other hand, if the device ID contained in the packet P2 is the same as the device ID stored in the memory 120 of the controller 104, then at step 318 the controller 104 sends the second message to the device 102 requesting receipt from the device 102 of the controller ID stored in the memory 110 of the device 102. Upon receipt of this second message, the device 102 retransmits to the controller 104 the third message, which has a payload which contains both the device ID and the controller ID stored in the memory 110 of the device 102. Upon receipt of the third message at step 320 the microcontroller 118 of the controller 104 compares the controller ID contained in the third message with the controller ID stored in memory 120. If the controller ID contained in the third message is the same as the controller ID stored in the memory 120 of the controller 104, then the connection between the device 102 and the controller 104 is resumed. Once the connection has been resumed, the device 102 stops the broadcast of the packet P2, but not the broadcasts of beacon B1 and packet P1.

However, if the controller ID contained in the third message is not the same as the controller ID stored in the memory 120 of the controller 104, then a connection is not established between the device 102 and the controller 104. This could occur in the event that a second controller had established a connection with the device 102 whilst the connection between the device 102 and the controller 104 was broken, and that connection between the device 102 and the second controller had subsequently become broken. In that event, the third message transmitted from the device 102 to the controller 104 would contain the controller ID of the second controller, which would be different from the controller ID of the controller 104. In this case, the device 102 continues to broadcast second packets P2, in addition to the broadcast of beacons B1 and packets P1, until a connection is made with a controller. If a user of the controller 104 were to require a wireless connection to be re-established with the device 102, the user would need to locate the controller 104 in the immediate proximity of the transceiver 106 to enable the controller 104 to receive the beacon B1 and packet P1 broadcast by the device 102, and thus enable steps 202-218 and 304-314 to be repeated between the device 102 and the controller 104. Once the connection is established between the device 102 and the controller 104, the broadcast of the packet P2 is stopped.

In summary, in a wireless communication between a mobile controller and a controllable device, the device periodically broadcasts, at a relatively low power level, a first advertisement packet for connecting the controllable device to a mobile controller. Once a connection has been established between the device and the controller, the controller and the device exchange their respective identifiers (IDs). In the event that the connection becomes broken, the device starts to additionally periodically broadcast, at a relatively high power level, a second advertisement packet containing the device ID for reconnecting the device to the controller. Upon receipt of the second packet, the controller requests receipt of a message containing the controller ID and, upon receipt of that message, resumes the connection with the device. The device then stops the broadcast of the second advertisement packet.

1. A method of establishing wireless connection between a mobile controller and a controllable device, comprising the steps of:
at the controllable device, which has a device identifier (ID):
(i) periodically wirelessly broadcasting, at a relatively low power level, from the controllable device a first advertisement packet for connecting the controllable device to a mobile controller;
at the mobile controller, which has a controller ID:
(ii) receiving the first advertisement packet;
(iii) establishing a wireless connection with the controllable device;
(iv) receiving the device ID from the connected controllable device; and
(v) storing the device ID;
at the controllable device:
(vi) receiving the controller ID for the connected mobile controller; and
(vii) storing the controller ID;
and, when the connection between the mobile controller and the controllable device becomes broken, further comprising the steps of:
at the controllable device:
(viii) additionally periodically wirelessly broadcasting, at a relatively high power level, a second advertisement packet for reconnecting the controllable device to the mobile controller, the second advertisement packet containing the device ID;
at the mobile controller:
(ix) receiving the second advertisement packet;
(x) comparing the device ID contained in the second advertisement packet with a stored device ID;
(xi) depending on the result of the comparison at step (x), requesting transmission of the controller ID stored by the controllable device;
(xii) receiving the stored controller ID from the controllable device;
(xiii) comparing the stored controller ID received from the controllable device with the controller ID of the mobile controller; and
(xiv) depending on the result of the comparison at step (xiii), resuming the wireless connection between the mobile controller and the controllable device; and
at the controllable device:
(xv) when the connection has been resumed, stopping the broadcast of the second advertisement packet.

2. The method of claim 1, wherein the first advertisement packet and the second advertisement packet are periodically broadcast at the same fixed interval.

3. The method of claim 2, wherein the fixed interval is in the range from 50 to 500 ms.

4. The method of claim 1, wherein the broadcasts of the first advertisement packet and the second advertisement packet are staggered.

5. The method of claim 1, wherein the first advertisement packet is broadcast to a distance of up to 30 cm.

6. The method of claim 1, wherein the first advertisement packet is broadcast to a distance of up to 15 cm.

7. The method of claim 1, wherein the second advertisement packet is broadcast to a distance in the range from 1 to 10 m.

8. The method of claim 1, wherein steps (vi) and (vii) are performed before steps (iv) and (v).

9. The method of claim 1, wherein the connection between the connected device and the mobile controller is replaced by a connection between the connected device and a second mobile controller having a unique second controller ID by performing steps (ii) to (vii) with the second mobile controller.

10. The method of claim 1, wherein a beacon for activating a program stored on the mobile controller is periodically wirelessly broadcast by the controllable device.

11. The method of claim 10, wherein the beacon is broadcast by the controllable device at the relatively low power level.

12. The method of claim 10, wherein the first advertisement packet and the beacon are periodically broadcast at the same fixed interval.

13. The method of claim 10, wherein the broadcasts of the first advertisement packet, the second advertisement packet and the beacon are staggered.

14. A controllable device for use in a wireless communication system, the controllable device comprising:
a transceiver;
a memory storing a device identifier (ID) associated with the device; and
a microcontroller connected to the transceiver and the memory, the microcontroller being configured to control the transceiver to periodically wirelessly broadcast, at a relatively low power level, a first advertisement packet for connecting the controllable device to a mobile controller, establish a connection between the controllable device and a mobile controller, receive from the transceiver a first message having a payload containing a controller ID for the connected mobile controller; and store the controller ID in the memory; and
wherein the microcontroller is configured to control the transceiver to additionally periodically wirelessly broadcast, at a relatively high power level, a second advertisement packet for reconnecting the controllable device to the mobile controller when the connection becomes broken, the second advertisement packet containing the device ID, receive from the transceiver a request for the stored controller ID, control the transceiver to transmit, in response to the request, a second message having a payload containing the stored controller ID, and stop the broadcast of the second advertisement packet when the connection with the mobile controller has been resumed.

15. The device of claim 14, wherein the microcontroller is configured to control the transceiver to periodically broadcast the first advertisement packet and the second advertisement packet at the same fixed interval.

16. The device of claim 15, wherein the fixed interval is in the range from 50 to 500 ms.

17. The device of claim 14, wherein the microcontroller is configured to control the transceiver to stagger the broadcasts of the first advertisement packet and the second advertisement packet.

18. The device of claim 14, wherein the microcontroller is configured to set the relatively low power level such that the first advertisement packet is broadcast to a distance of up to 30 cm.

19. The device of claim 14, wherein the microcontroller is configured to set the relatively low power level such that the first advertisement packet is broadcast to a distance of up to 15 cm.

20. The device of claim 14, wherein the microcontroller is configured to set the relatively high power level such that the second advertisement packet is broadcast to a distance in the range from 1 to 3 m.

21. The device of claim 14, wherein the microcontroller is configured to control the transceiver to periodically wirelessly broadcast a beacon for activating a program stored on the mobile controller device.

22. The device of claim 21, wherein the microcontroller is configured to control the transceiver to broadcast the beacon at the relatively low power level.

23. The device of claim 21, wherein the microcontroller is configured to control the transceiver to broadcast the first advertisement packet and the beacon at the same fixed interval.

24. The device of claim 21, wherein the microcontroller is configured to control the transceiver to stagger the broadcasts of the first advertisement packet, the second advertisement packet and the beacon.
